(19) United States
(12) Patent Application Publication
(10) Pub. No.: US 2011/0073492 A1
(43) Pub. Date: Mar. 31, 2011

(54) Voltammetric Biological Sensor

(75) Inventors: Alton J. Reich, Huntsville, AL (US); Stephen J. Doherty, New Hope, AL (US)

(73) Assignee: STREAMLINE AUTOMATION, LLC, Huntsville, AL (US)

(21) Appl. No.: 12/342,423

(22) Filed: Dec. 23, 2008

Related U.S. Application Data
(60) Provisional application No. 61/009,172, filed on Dec. 26, 2007.

(51) Int. Cl. G01N 27/406; G01N 27/26

(52) U.S. Cl. 205/777.5; 204/403.01; 205/792

(57) ABSTRACT

A sensor and method sense and quantify microorganisms and other biological materials. The sensor and method use high device temperatures to pyrolize and/or thermolyze biological materials, then gas-phase voltammetry is used to analyze the pyrolysis or thermolysis products to detect and identify the source biological material. The sensor and method are capable of differentiating between biological agents, such as pollen, bacteria, fungi, and their spores and the state of an organism such as living, diseased, or non-living. The sensor and method may operate at temperatures sufficient to be self-cleaning and self-decontaminating or at non-elevated temperatures to detect and identify combinations of volatile metabolites to detect and identify their biological sources.

### CROSS-REFERENCE TO RELATED APPLICATIONS

This application claims priority under 35 U.S.C. 119 (e) to U.S. Provisional Application Ser. No. 61/009,172, filed 26 Dec. 2007.

### STATEMENT REGARDING FEDERALLY SPONSORED RESEARCH OR DEVELOPMENT

The U.S. Government has certain rights to this invention pursuant to Contract No.:H92222-07-P-0035.

### BACKGROUND OF THE INVENTION

1. Field of the Invention

The present invention relates to biological sensors for sensing microorganisms and other biological materials. More specifically, the invention is a solid-state voltammetric sensor and pyrolysis/thermolysis-enhanced gas voltammetry analysis method.

2. Description of Related Art

U.S. Pat. No. 5,429,727 to Vogt et al. discloses an electrocatalytic device for voltammetrically sensing gases. The device comprises a substrate layer, a reference electrode disposed on the substrate layer, a lower electrical reference electrode coupled to a solid electrolyte, and an upper catalytically active electrode. The device is disclosed as being useful for detecting water vapor, and gaseous organic chemicals at lower temperatures than existing metal-oxide-based sensors.

U.S. Pat. No. 5,772,863 to Shoemaker et al. discloses a materialistically enhanced voltammetric sensor for sensing oxygen and carbon dioxide gasses. The sensor comprises a plurality of layers including an inert metal oxide substrate, a reference electrode source of reactive ions, a lower electrical reference electrode of noble metal coupled to the reference source of ions, a solid electrolyte containing reaction-enhancing metal and coupled to the lower electrical reference electrode, a zirconia solid electrolyte, and an upper catalytically active noble metal electrode coupled to the buffer layer. The sensor is disclosed as being useful for sensing oxygen, carbon dioxide, carbon monoxide, nitrogen, and hydrocarbons.

The voltammetric sensors of the prior art are not designed for distinguishing between complex mixtures of gasses or sensing biological materials such as bacteria, fungi, spores, or viruses. The present invention is based, in part, on the unexpected discovery that voltammetric sensor technology can be adapted to distinguish between complex mixtures of gases resulting from the pyrolysis or thermolysis of biological materials including organisms and microbes.

### BRIEF SUMMARY OF THE INVENTION

The present invention is a sensor and method capable of sensing microbes, organisms, and other biological materials by pyrolizing or thermolyzing the biological materials and detecting and identifying pyrolysis or thermolysis products to sense and identify the source biological material. The present sensor and method are capable of differentiating between biological materials, such as pollen, bacteria, fungi, and their spores and may also be used to determine a metabolic state of an organism. The present sensor and method may operate at elevated temperatures sufficient to be self-cleaning and self-decontaminating.

### BRIEF DESCRIPTION OF THE SEVERAL VIEWS OF THE DRAWINGS

FIG. 1 is an exploded view showing the components of a sensing element and its location within a housing with pin connectors for one embodiment of the present invention.

FIG. 2 is a diagram illustrating the use of crimped leads on the contact pads of a sensing element.

FIG. 3 is a schematic of the components of one embodiment of a voltammetric biological sensor.

FIG. 4 shows voltammetric signatures for dried ragweed pollen placed directly on the working electrode of a biosensor at different temperatures.

FIGS. 5A and B shows the results of biological pyrolysis/thermolysis-voltammetry of rye and ragweed pollen.

FIG. 6 shows the voltammetric profiles of three different bacteria in growth media contacted with the working electrode of the sensing element of a voltammetric biological sensor.

FIGS. 7A and B are voltammograms of B. thuringiensis and B. subtilis spores in agar with the background signals for air (A) and air and agar (B) subtracted.

FIG. 8 shows the voltammograms of gases originating from living and non-living roaches.

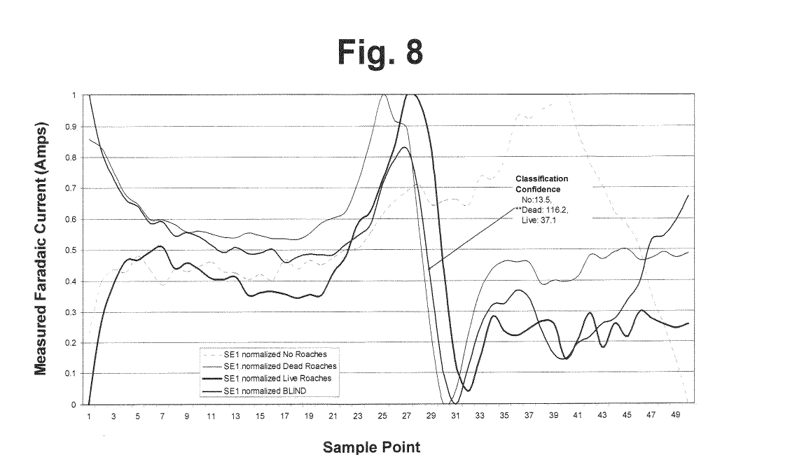

### DETAILED DESCRIPTION OF THE INVENTION

The voltammetric sensor of the present invention comprises one or more solid-state electrochemical cells. Each electrochemical cell comprises a reference electrode and a working electrode, separated by a solid electrolyte. The electrochemical cell is formed in layers on a substrate with the reference electrode formed directly on the substrate or separated from the substrate by a layer of metal oxide such as Nickel oxide. A solid electrolyte such as Tungsten-stabilized Bismuth Oxide (WBO), Ytria-stabilized Zirconia (YSZ), or Gadolinium-dopes Cerium oxide (GDC), optionally doped with a metal oxide is layered onto the reference electrode. The working electrode is then layered onto the solid electrolyte. The reference and working electrodes alternately act as either a cathode or an anode, depending on the instantaneous potential applied to the electrochemical cell.

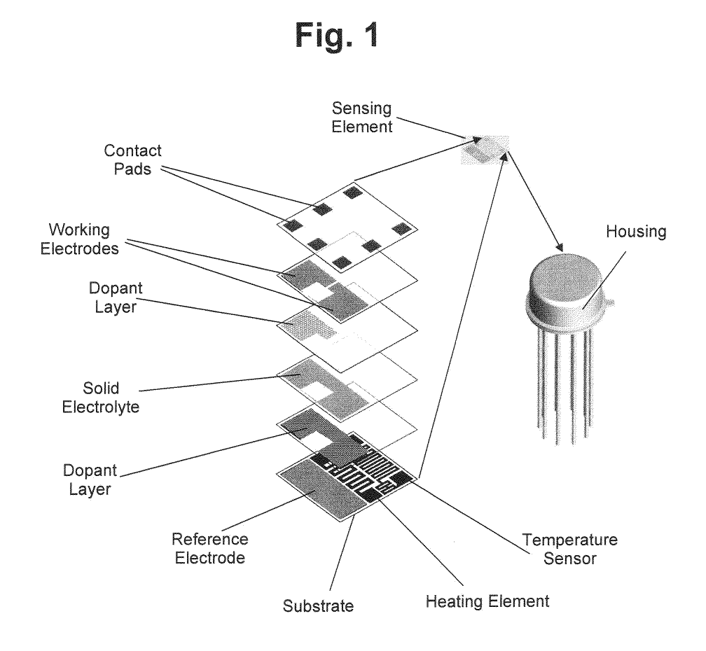

FIG. 1 shows an electrochemical cell sensing element of a voltammetric sensor according to the present invention. The sensing element may contain a single electrochemical cell, a single reference electrode and a plurality of working electrodes to form an array of electrochemical cells, or a plurality of reference electrodes and a plurality of working electrodes to form an array of electrochemical cells (sensor array). The sensing element preferably comprises a heating element that heats the sensing element to operating temperature. The heating element may additionally be used to sterilize and self-clean the sensing element.

The sensing element shown in FIG. 1 comprises a substrate upon which a reference electrode is formed. The substrate must be made of a non-conducting material capable of withstanding the temperatures used by the sensing element such as glass, silicon, silicon oxide, silicon carbide, or a ceramic such as alumina. The reference electrode is preferably made of a noble metal such as platinum or gold. In this embodiment, a heating element and a heat sensor are also formed on the substrate. The heating element and temperature sensor may be coated with a thermally conducting, electrically insulating material. This embodiment includes a metal oxide dopant layer formed on top of the reference electrode. A solid electrolyte is layered on the metal oxide dopant. A portion of the solid electrolyte is coated with a metal oxide dopant layer and separate working electrodes are formed over the doped and non-doped solid electrolyte, respectively, to form two separate electrochemical cells, or a two-member sensor array. Conducting contact pads are layered onto the two working electrodes, the heating element, and the temperature sensor. The square outlines in the figure are used only to indicate outline of the sensor element. The sensor element is placed within a housing having an opening (not shown) to allow a test sample to contact the sensing element. A test sample may be a gas, liquid, solid, or suspension. If a test sample is in liquid, solid, or suspended form, it may be contacted with any portion of the sensing element and is preferably contacted with the heating element or working electrode(s).

The sensing element may be constructed using thick-film, thin-film, or hybrid fabrication methods. Thick-film methods typically involve precision lithography using suspensions of the sensor material in a vehicle that results in a paste-like consistency. These pastes are deposited on a substrate by forcing them through a printing screen. Several layers of material are deposited and built up, with each layer being sintered at temperatures characteristic for that material. The sintering process causes the vehicle to vaporize and forms the microstructure of the solid sensor component. The successive layers, chiefly the electrode—electrolyte—electrode structure, create the electrochemical cell that is active in the voltammetric sensor.

The sensing element can also be constructed using thin-film techniques that are typical for fabricating micro-electro-mechanical (MEMs) devices. The basic, final structure is the same—an electrolyte with optional dopants sandwiched between two electrodes. The materials can be deposited by any of several techniques, including electron beam deposition, sputtering, and chemical vapor deposition. Depending on the materials being deposited, a standard photo-masking process can be used, or a lift-off process may be required. The sensor may be fabricated on silicon, silicon dioxide, alumina, or other substrates based on the requirements of the application.

Hybrid sensors can be fabricated using a combination of thin-film and thick-film techniques. An example of this would be a sensor with the heating element, temperature sensing element, and lower electrode fabricated with thick-film techniques, and the electrolyte deposited using thin-film techniques.

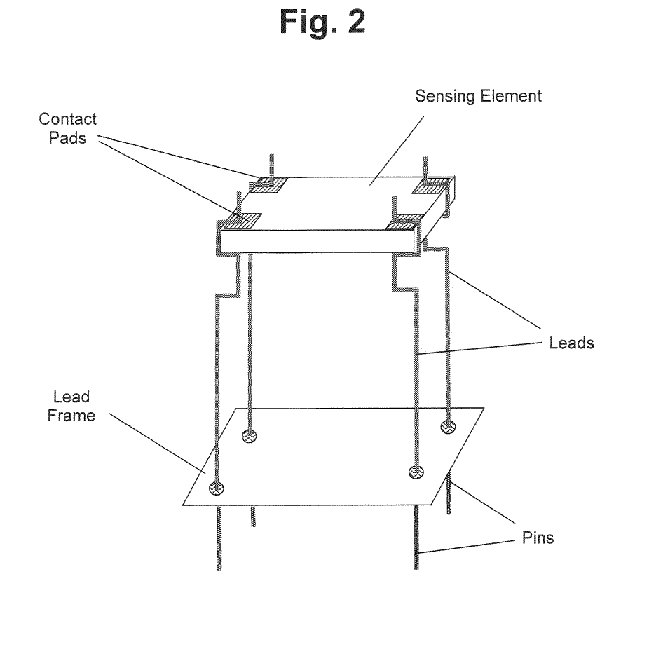

Sensors capable of characterizing pyrolytic/thermolytic off-gassing from biological materials using voltammetric microarrays and gas voltammetry optimally require operating temperatures greater than 230° C. These operating temperatures adversely affect the eutectic solder chemical components found on conventional biosensor land (pad) materials when the solder's melting temperature is exceeded. For this reason, purely mechanical connections between wiring and the sensor element are preferred. The wires may be crimped into the leads, and the leads spring-loaded against the pads on the sensor surface. Alternatively, high-strength Nickel 201, 301 Stainless Steel, or similar high-temperature capable solder-less leads may be used. FIG. 2 shows a sensing element having four connection pads and four leads crimped onto the connection pads and attached to a lead frame with pins connected to the leads for coupling to a printed circuit board. The sensor array is contained in a sensor housing made of metal, a thermoplastic, or other material that withstands high temperature operation. A lead frame can be designed to be flexible and provide additional stand-off distance from a thermoplastic DIP (dual in-line package) socket, for example. In such a configuration, the leads provide a mechanical-electrical connection to the cermet substrate that withstands high sensor temperatures. The leads can be chemically machined from thin plate Nickel 201 or 301 stainless steel, and delivered as a frame for die-forming. A stainless steel or similar material die can be machined to form the leads.

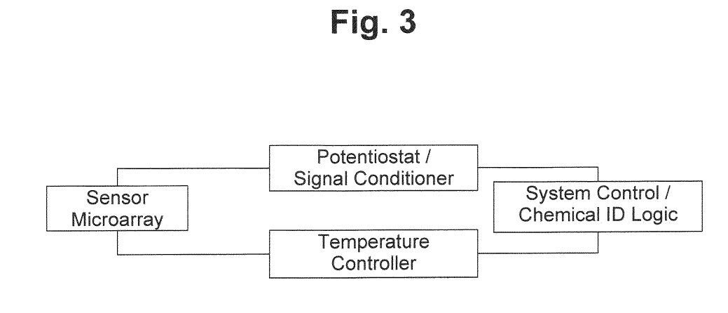

The sensor/sensor array comprises or communicates with a potentiostat/signal conditioner to convert current to voltage and amplify the output signal (FIG. 3). The sensor/sensor array preferably also includes a temperature controller to set and control sensor temperature and/or a system controller that provides excitation potential and executes chemical identification routines.

The sensor is generally operated by the following procedure, although variations are possible. Power is applied to the heater and the temperature of the sensor is allowed to rise to the operating temperature. The heater power is adjusted either manually or automatically to maintain the sensor temperature close to the desired temperature. An excitation voltage is generated by a voltage source, such a computer or embedded processor through a discrete or integral digital-to-analog converter, and applied to the reference electrode(s) or working electrode(s) of the sensing element. The preferred embodiment comprises a single reference electrode and multiple working electrodes with the excitation potential applied to the reference electrode. The excitation voltage is varied in time. A simple ramp (triangular wave), or an approximation of a ramp (rising step function), or a more complex excitation waveform such as a rising square wave function can be used. The working electrodes of the sensor array are each connected to a virtual ground at an operation amplifier that converts the current flowing through the electrochemical cell to a voltage, and applies a gain to amplify the indicated voltage. The output of the amplifier may be processed through a low-pass filter to remove noise prior to it going to an analog-to-digital converter.

The sensor raw output is a spectrum of current vs. applied electrode potential. The current is calculated from the output voltage of the operational amplifier. The spectrum for the pyrolysis/thermolysis products of a biological material is used as a voltammetric signature for the biological material. The signature can then be compared to the spectrum of an unknown biological sample to sense, identify, and/or quantify the presence of the biological material in the unknown sample.

The present pyrolysis/thermolysis voltammetric method was demonstrated using a commercial solid electrolyte electrochemical cell. The analytical use of this cell is improved by using a voltammetric measurement technique, which is distinct from the potentiometric measurement technique normally employed with such cells. The commercial cell is not optimally designed for the present method because it requires dramatically higher power consumption and its geometry, lithography, and materials are not designed for voltammetric detection of biologicals as is the biosensor described herein. Nevertheless, the cell employed a Pt/YSZ/Pt lithography similar enough to the fundamental voltammetric sensor lithography to adequately demonstrate the present method.

### Example

### Pollen Tests

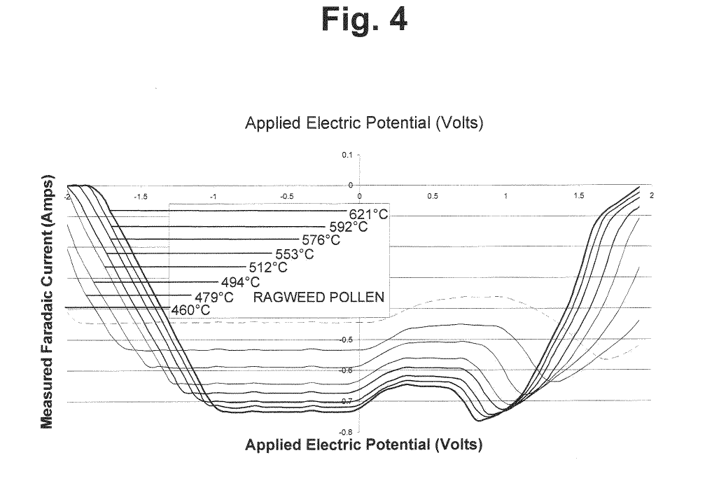

FIG. 4 shows the results of contacting an electrochemical cell with to dried Ragweed pollen at different temperatures to generate a series of voltammetric signatures. Similar results were obtained for Rye pollen.

### Example

### Pyrolysis/Thermolysis Effective Temperatures

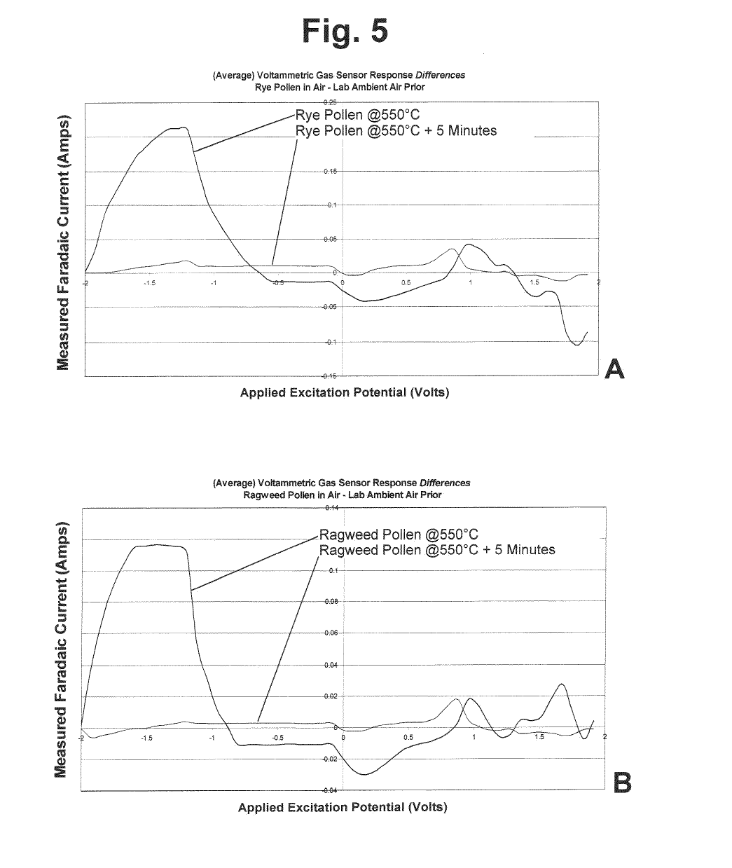

Results of biological pyrolysis/thermolysis-voltammetry of Rye and Ragweed pollen samples at 550° C. are shown in FIGS. 5A and B. This demonstrates the sensing of different biological materials by the voltammetric method and the correlation of the identities of biological samples based on the spectra of chemicals generated by their pyrolysis/thermolysis.

### Example

### Bacterial Identification

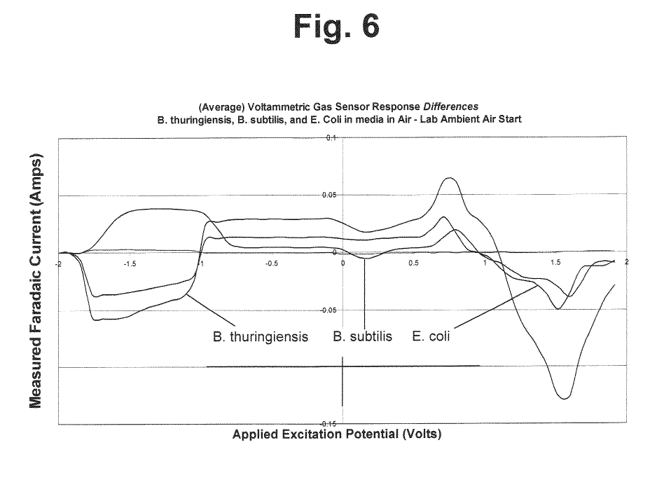

Gram-positive B. thuringiensis and B. subtilis sporulates, and Gram-negative E. coli non-sporulates in growth media were contacted with the sensing element of a voltammetric sensor. FIG. 6 shows the voltammetric profiles of the three bacteria with the signal for ambient air subtracted. The profile of each bacterium is unique and distinct from the other bacteria.

### Example

### Numerical Separation of Organisms from Air and Growth Media

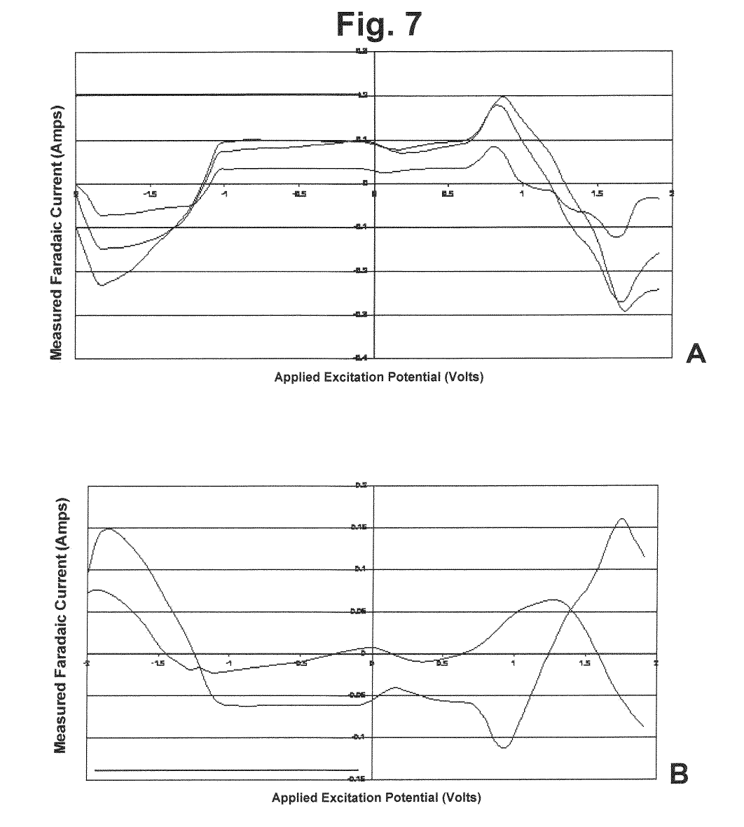

The detection identification and quantification of biological samples using the present method may be improved by using numerical techniques that isolate and remove the voltammetric signatures of background and contaminating materials. The numerical separation of Air and growth media pyrolysis/thermolysis+gas voltammetry signatures from bacterial spore signatures is shown in FIGS. 7A and B. FIG. 7A shows the voltammograms of B. thuringiensis spore, B. subtilis spore, and agar signatures with the background air signal removed. FIG. 7B shows the voltammograms of B. thuringiensis spore and B. subtilis spore signatures with both the background air and agar signal removed.

In cases where sample components produce similar chemicals, but not in the same ratios and/or amounts, a calibration procedure can be used to extract the voltammetric signatures of background or confounding materials. The amino acids and proteins unique to each species likely account for the similar, but distinct signatures, with similar reaction features indicating spores. The features occur at different potentials, allowing discrimination between bacteria and bacterial spores.

The present method coupling a pyrolysis/thermolysis technique with gas voltammetry can identify biological species, including spores. This technique can be further improved using an additional methodology. When a biological or chemical material is pyrolized or thermolized, that process also gives off a unique chemical signature as a by-product emission. Individual species produce unique characteristic gases as they reproduce and metabolize growth media, be it a solid agar or a liquid broth. The combination of detectable off-gases plus the pyrolyzed biological material allow for both identification of the production of the materials, and accurate identification using the same voltammetric technology. This voltammetric sensing technology may be used as a background atmospheric emissions [chemical] sensor and as a pyrolytic [solid cellular] bacterial detection sensor to significantly improve discrimination and confidence in detection. The sensors can be programmed to regularly monitor chemical signatures (e.g. searching for the production gases) and, when they are detected in characteristic ratios, the exact same sensor can be operated pyrolytically to identify biological material and produce an estimation of its abundance. Such a sensor system may be used, for example, to detect food spoilage, insect infestations, clinically diagnose infections and metabolic disorders, and to locate or verify suspected manufacturing sites of illicit drugs and/or biological and chemical weapons.

A combined chemical-biological sensor may operate at the relatively low temperatures for chemical detection. On a pre-set schedule the temperature of the sensing element may be increased to approximately 500° C., a temperature high enough to thermolyze biological materials. The sensing element may be kept at that temperature for a few minutes to detect and quantify biological agent before cooling back to chemical sensing temperature. This method may be performed by a sensing system comprising electrostatic elements to collect and “steer” or concentrate particulates toward the sensing element.

A number of specific embodiments of the invention are referenced to describe various aspects of the present invention. It is not intended that such references be construed as limitations upon the scope of this invention except as set forth in the following claims.

What is claimed is:

1. A voltammetric biosensor comprising:
a sensing element comprising a dry electrochemical cell comprising a substrate; a reference electrode, a solid electrolyte, and a working electrode;
a heating element;
a power supply; and
an operational amplifier configured to convert an output current from the sensing element into an output voltage and to amplify the output current during conversion to voltage; wherein:
the solid electrolyte is in contact with both the reference electrode and the working electrode
the heating element is configured to heat the electrochemical cell to a temperature sufficient to pyrolize or thermolyze a biological sample contacting the electrochemical cell or the heating element; and
the power supply and dry electrochemical cell are configured such that an excitation potential can be generated between the reference and working electrodes.

2. The voltammetric biosensor of claim 1, wherein the reference electrode is formed directly on the substrate or on a metal oxide layer on the substrate.

3. The voltammetric biosensor of claim 2, wherein the substrate of the electrochemical cell is selected from the group consisting of glass, silicon, silicon oxide, silicon carbide and a ceramic.

4. The voltammetric biosensor of claim 1, wherein the sensing element comprises a plurality of working electrodes to form a biosensor array.

5. The voltammetric biosensor of claim 1, wherein the sensing element comprises a plurality of reference electrodes and a plurality working electrodes to form a biosensor array.

6. The voltammetric biosensor of claim 1, and further comprising a temperature sensor and a temperature controller, configured to control the temperature of the electrochemical cell.

7. The voltammetric biosensor of claim 1, and further comprising a system controller configured to control the excitation potential between the reference and working electrodes, and configured to execute a software program to identify the biological sample contacting the electrochemical cell.

8. The voltammetric biosensor of claim 1, wherein the biological sample is selected from the group consisting of a microorganism, a liquid containing a microorganism, a volatile gas originating from an organism, and a fluid originating from an organism.

9. The voltammetric biosensor of claim 1, wherein the heating element is an integral part of the sensing element.

10. A voltammetric method for sensing a biological material in a test sample comprising the method steps of:
a) contacting the test sample with a sensing element of a voltammetric biological sensor comprising:
a sensing element comprising a dry electrochemical cell comprising a substrate;
a reference electrode, a solid electrolyte, and a working electrode;
a heating element;
a power supply; and
an operational amplifier configured to convert an output current from the sensing element into an output voltage and to amplify the output current during conversion to voltage; wherein:
the solid electrolyte is in contact with both the reference electrode and the working electrode
the heating element is configured to heat the electrochemical cell to a temperature sufficient to pyrolize or thermolyze a biological sample contacting the electrochemical cell or the heating element; and
the power supply and dry electrochemical cell are configured such that an excitation potential can be applied between the reference and working electrodes;
b) variably controlling the temperature of the electrochemical cell within a predetermined temperature range;
c) applying a variable and controlled excitation potential between the reference and working electrodes;
d) measuring an output voltage from the operational amplifier as a function of excitation potential;
e) correlating the output voltage or the output current of the sensing element with the applied excitation potential to generate a sample signature, and
f) comparing the sample signature to at least one control sample signature to sense the presence or absence of the biological material in the test sample.

12. The method of claim 10 wherein the variable and controlled excitation potential is applied in the form of a triangular wave or a rising step function.

13. The method of claim 10, wherein the biological material is selected from the group consisting of an organism, a liquid originating from an organism, and a mixture of volatile gases originating from an organism.

14. The method of claim 12 wherein the organism is a microorganism.

15. The method of claim 13 wherein the microorganism is selected from a bacterium, a bacterial spore, a fungus, a fungal spore, and a virus.
